(19) United States
(12) Patent Application Publication
(10) Pub. No.: US 2024/0295855 A1
(43) Pub. Date: Sep. 5, 2024

(54) TIMEPIECE DIAL AND TIMEPIECE

(71) Applicant: SEIKO WATCH KABUSHIKI KAISHA (trading as SEIKO WATCH CORPORATION), Tokyo (JP)

(72) Inventor: Yasunori HARA, Tokyo (JP)

(21) Appl. No.: 18/586,900

(22) Filed: Feb. 26, 2024

(30) Foreign Application Priority Data
Mar. 2, 2023 (JP) 2023-031547

(51) Int. Cl. G04B 19/06; G04B 45/00

(52) U.S. Cl. CPC G04B 19/06; G04B 45/0084

(57) ABSTRACT

To provide a timepiece dial and a timepiece capable of forming a surface decoration due to unevenness on a substrate and to facilitate polishing work on a substrate surface. A timepiece dial includes a first substrate on which an index protrudes from a first main surface, and a second substrate overlapped on the first main surface. A through hole through which the index is inserted and exposed is formed in the second substrate. A surface decoration having unevenness is formed on the second substrate.

### RELATED APPLICATIONS

This application claims priority to Japanese Patent application No. JP2023-031547, filed on Mar. 2, 2023, the entire content of which is incorporated herein by reference.

### BACKGROUND OF THE INVENTION

### 1. Field of the Invention

The present invention relates to a timepiece dial and a timepiece.

### 2. Description of the Related Art

An index indicating time or the like is formed on a surface of a timepiece dial. For example, when a normal operation is always required as in a diver's watch or the like, the index may be formed by a substrate of the dial being molded into a convex shape (see, for example, PTL 1). In this dial, the index is integrated with the substrate, and thus the index is less likely to fall off. Therefore, it is possible to reduce a possibility of a failure formed by a falling piece.

### 3. Citations

Patent Literature: [PTL 1] JPH05-119163A

In the dial described above, in general, the index is formed by press molding or the like using a thin plate (plate material) in consideration of processability. Therefore, when a surface decoration due to unevenness is formed on the substrate, a height of the unevenness may be restricted by a thickness of the plate material to be used for manufacturing reasons. Further, when the surface decoration due to the unevenness is formed on the substrate, a defect such as deformation of the substrate is likely to occur. Therefore, it is difficult to form a surface decoration having a three-dimensional appearance on a substrate surface. In the above dial, when the substrate surface is polished in order to impart gloss, polishing work may be difficult due to the protruding index.

### SUMMARY OF THE INVENTION

It is an aspect of the present application to provide a timepiece dial and a timepiece capable of forming a surface decoration due to unevenness on a substrate and to facilitate polishing work on a substrate surface.

(1) A timepiece dial includes: a first substrate on which an index protrudes from a first main surface; and a second substrate overlapped on the first main surface, in which a through hole through which the index is inserted and exposed is formed in the second substrate, and a surface decoration having unevenness is formed on the second substrate.

According to this configuration, since there is no index on the second substrate, a defect such as deformation is less likely to occur when the surface decoration due to the unevenness is formed. In addition, the second substrate is separated from the first substrate, and thus the second substrate is less likely to be restricted by a thickness of a plate material to be used, and a height of the unevenness is easily secured. Therefore, the surface decoration having deep unevenness can be formed as compared with a case in which both the index and the surface decoration are formed on the substrate. Thus, a surface decoration having a three-dimensional appearance can be formed. In this manner, there are few restrictions on the surface decoration, and thus a degree of freedom in design can be improved.

According to this configuration, it is possible to polish an upper surface of the second substrate and impart gloss to the upper surface of the second substrate before being bonded to the first substrate. Since there is no index on the second substrate, the second substrate has a small number of surface protrusions that may hinder the polishing work. Therefore, the polishing work is facilitated.

(2) In the timepiece dial according to (1), a surface of the second substrate is covered with a transparent resin layer.

According to this configuration, since the surface of the second substrate is covered with the transparent resin layer, a three-dimensional and deep visual effect can be imparted to the surface decoration.

(3) In the timepiece dial according to (1) or (2), the first substrate and the second substrate are formed of one or two or more of a metal, ceramics, glass, and plastics, and the metal is an alloy containing one or two or more of (A) copper, (B) iron, (C) titanium, (D) gold, (E) silver, and (F) platinum, or an alloy in which one or two or more of (A) to (F) are taken as main components.

According to this configuration, by using these materials, it is possible to facilitate processing of the first substrate and the second substrate and to reduce costs.

(4) In the timepiece dial according to any one of (1) to (3), the second substrate is subjected to a surface treatment by at least one of coating, printing, wet plating, and dry plating.

According to this configuration, designability of the second substrate can be improved with these surface treatments.

(5) In the timepiece dial according to any one of (1) to (4), the first substrate and the second substrate are bonded by at least one of an adhesive, a double-sided tape, and caulking.

According to this configuration, the first substrate and the second substrate are bonded and integrated with each other, so that a handling property of the timepiece dial is improved.

(6) A timepiece includes: the timepiece dial according to any one of (1) to (5).

According to this configuration, as described above, the surface decoration having the deep unevenness can be formed as compared with the case in which both the index and the surface decoration are formed on the substrate. Thus, a surface decoration having a three-dimensional appearance can be formed.

According to this configuration, it is possible to polish the upper surface of the second substrate and impart gloss to the upper surface of the second substrate before being bonded to the first substrate. Since there is no index on the second substrate, the second substrate has a small number of surface protrusions that may hinder the polishing work. Therefore, the polishing work is facilitated.

According to one aspect of the application, it is possible to provide a timepiece dial and a timepiece capable of forming a surface decoration due to unevenness on a substrate and to facilitate polishing work on a substrate surface.

### BRIEF DESCRIPTION OF THE DRAWINGS

FIG. 1 is a cross-sectional view of a timepiece including a timepiece dial according to a first embodiment.

FIG. 2 is a cross-sectional view of the timepiece dial according to the first embodiment.

FIG. 3 is a cross-sectional perspective view of a part of the timepiece dial according to the first embodiment.

FIG. 4 is a perspective view of the timepiece dial according to the first embodiment.

FIG. 5 is an exploded perspective view of the timepiece dial according to the first embodiment.

FIG. 6 is a partial cross-sectional view of a timepiece dial according to a second embodiment.

FIG. 7 is a partial cross-sectional view of a timepiece dial according to a third embodiment.

### DETAILED DESCRIPTION OF THE PREFERRED EMBODIMENTS

Hereinafter, embodiments of the invention will be described with reference to the drawings.

### [Timepiece]

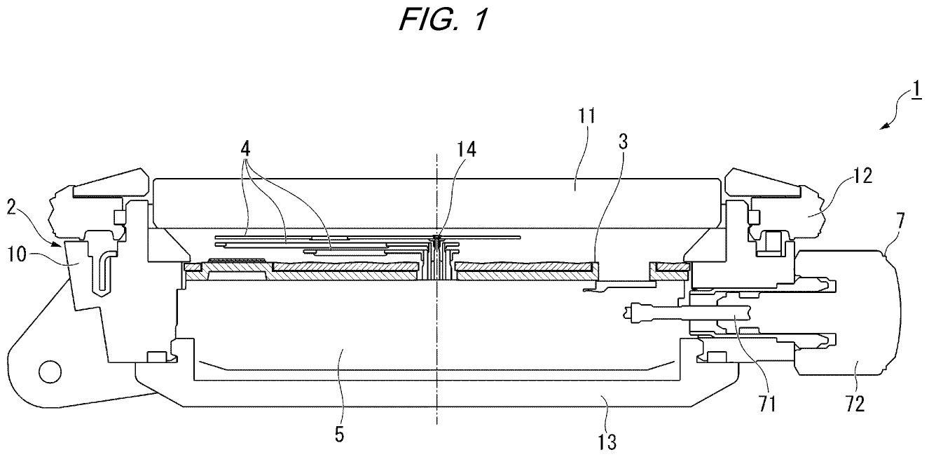

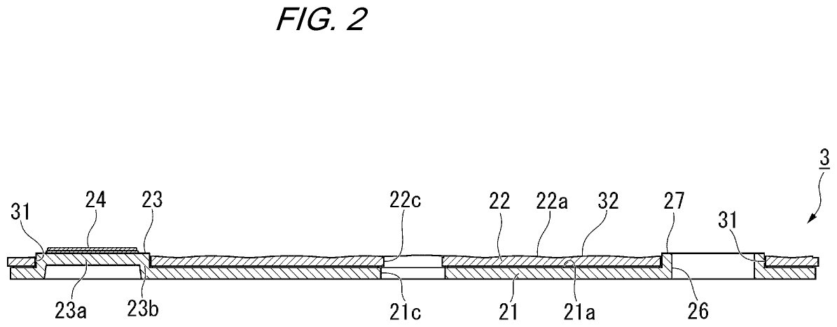

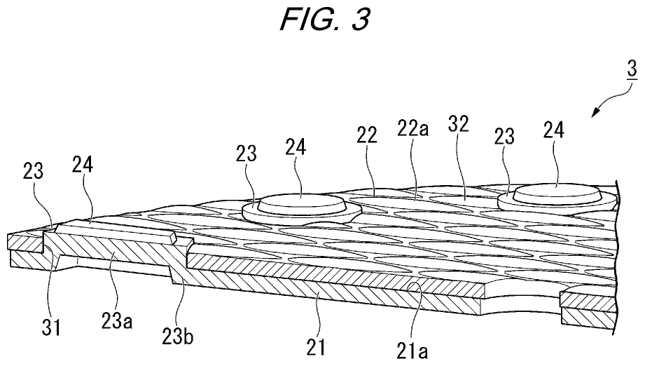

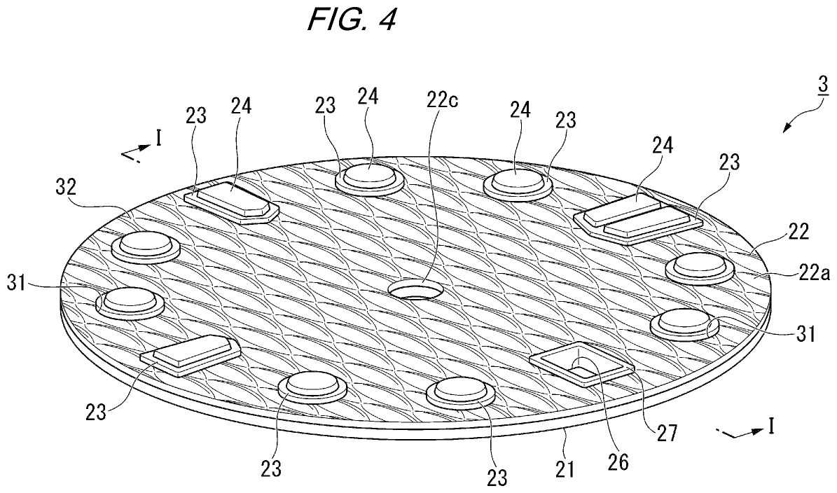

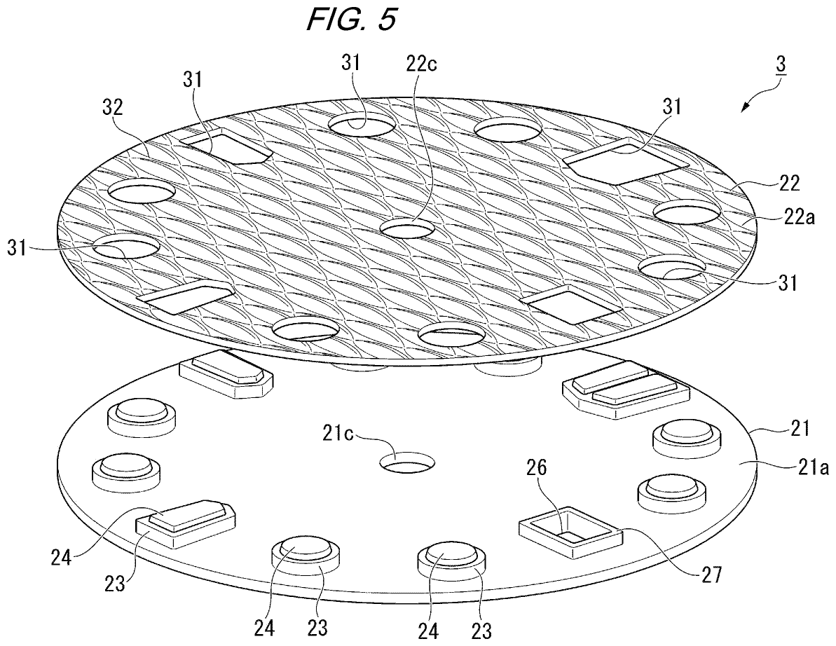

FIG. 1 is a cross-sectional view of a timepiece 1 including a dial 3 according to a first embodiment. FIG. 2 is a cross-sectional view of the dial 3. FIG. 3 is a cross-sectional perspective view of a part of the dial 3. FIG. 4 is a perspective view of the dial 3. FIG. 5 is an exploded perspective view of the dial 3. FIGS. 2 and 3 are cross-sectional views taken along a line I-I in FIG. 4.

As illustrated in FIG. 1, the timepiece 1 includes a timepiece case 2, the dial 3, hands 4, a timepiece movement 5, and a rotation operation unit 7.

The timepiece case 2 (case) includes a case main body 10, glass 11, a bezel 12, and a case back 13. The case main body 10 is formed in a cylindrical shape. The glass 11 closes one opening of the case main body 10. The bezel 12 is provided at one opening end of the case main body 10. The bezel 12 holds the glass 11. The case back 13 closes the other opening of the case main body 10. The timepiece case 2 accommodates the dial 3, the hands 4, and the movement 5.

Hereinafter, positions and the like of components are temporarily determined with reference to FIG. 1. For example, the glass 11 is located above the case back 13. The positions and the like illustrated here do not limit postures of the timepiece 1 during use.

The hands 4 are disposed between the dial 3 and the glass 11. The hands 4 are attached to a rotation shaft 14 of the movement 5. The movement 5 is disposed between the dial 3 and the case back 13. The movement 5 includes a drive source that drives the rotation shaft 14. The rotation shaft 14 extends from a center of the dial 3 in a direction orthogonal to the dial 3.

The rotation operation unit 7 includes a rotation shaft portion 71 and a head portion 72. The rotation operation unit 7 (crown) causes rotation operations of components in the movement 5.

### [Timepiece Dial]

### First Embodiment

As illustrated in FIG. 4, the dial 3 (timepiece dial) is formed in a circular plate shape. The dial 3 is visible through the glass 11 (see FIG. 1). A view from a direction orthogonal to the dial 3 is referred to as a plan view.

As illustrated in FIG. 5, a first substrate 21 and a second substrate 22 are provided.

The first substrate 21 is formed in a circular plate shape. The first substrate 21 is formed of, for example, one or two or more of a metal, ceramics, glass, and plastics. Examples of the metal forming the first substrate 21 include an alloy containing one or two or more of (A) copper, (B) iron, (C) titanium, (D) gold, (E) silver, and (F) platinum, or an alloy in which one or two or more of (A) to (F) are taken as main components. A “main component” is, for example, a component exceeding 50% by mass with respect to all the components. By using these materials, it is possible to facilitate processing of the first substrate 21 and to reduce costs.

A central hole 21c through which the rotation shaft 14 is inserted is formed at a center of the first substrate 21. The central hole 21c penetrates the first substrate 21 in a thickness direction.

A plurality of indexes 23 are formed on an upper surface 21a (first main surface) of the first substrate 21. The indexes 23 are, for example, displays that indicate time. The indexes 23 are formed, for example, at positions close to an outer peripheral edge of the first substrate 21 at intervals in a circumferential direction of the first substrate 21. The plurality of indexes 23 are formed, for example, at positions indicating 1 o'clock to 12 o'clock, respectively.

A shape of the index 23 is not particularly limited. The index 23 is in the shape of, for example, a figure, a character, or a symbol. The index 23 may have, for example, a bar shape along a radial direction of the first substrate 21 in the plan view, or may have a circular shape, a triangular shape, a trapezoidal shape, or a numeral (Arabic numerals, Roman numerals, or the like) shape. The index 23 is also referred to as an hour-marker.

As illustrated in FIGS. 2 and 3, the index 23 protrudes upward from the upper surface 21a of the first substrate 21. The index 23 includes, for example, an upper wall 23a and a side wall 23b. The side wall 23b has, for example, a skirt shape expanding downward from a peripheral edge of the upper wall 23a.

A protruding height of the index 23 is determined such that, for example, a part of the index 23 protrudes upward from an upper surface 22a of the second substrate 22 (see FIG. 3). Accordingly, visibility of the index 23 can be enhanced.

The index 23 is formed in a convex shape by pressing the first substrate 21 or the like. A method of forming the index 23 is not particularly limited. The index 23 can also be formed by surface cutting when the first substrate 21 is manufactured. When the first substrate 21 is made of plastics or the like, the index 23 may also be formed by a molding method such as injection molding.

A display layer 24 containing a phosphorescent material may be formed on a surface of the index 23. The phosphorescent material absorbs energy by receiving a stimulus of light, converts the absorbed energy into visible light, and emits light even after the stimulus is stopped. By adopting the display layer 24 made of the phosphorescent material, the index 23 can be easily visually recognized even in a dark place. When the display layer 24 exhibits a color different from that of the first substrate 21, visibility of the display layer 24 can be enhanced. The display layer 24 may be formed of a fluorescent material. The display layer 24 can be formed by printing, coating, or the like. The display layer 24 may be separated from the index 23 and attached to the surface of the index 23.

The first substrate 21 is formed with a calendar window 26 through which date characters and the like formed as a date indicator and a day indicator can be visually recognized. The calendar window 26 is formed in a rectangular shape in the plan view. A rectangular frame-shaped protrusion 27 surrounding the calendar window 26 is formed on the first substrate 21. The frame-shaped protrusion 27 protrudes upward from the upper surface 21a of the first substrate 21. Similarly to the index 23, the frame-shaped protrusion 27 is formed in a convex shape protruding upward from the upper surface 21a by pressing or the like. Similarly to the index 23, a protruding height of the frame-shaped protrusion 27 may be determined so as to protrude higher than the upper surface 22a of the second substrate 22.

The second substrate 22 is overlapped on the upper surface 21a of the first substrate 21.

The second substrate 22 is formed in a circular plate shape having the same diameter as the first substrate 21. The second substrate 22 is formed of, for example, one or two or more of a metal, ceramics, glass, and plastics. Examples of the metal forming the second substrate 22 include an alloy containing one or two or more of (A) copper, (B) iron, (C) titanium, (D) gold, (E) silver, and (F) platinum, or an alloy in which one or two or more of (A) to (F) are taken as main components. By using these materials, it is possible to facilitate processing of the second substrate 22 and to reduce costs.

A central hole 22c through which the rotation shaft 14 is inserted is formed at a center of the second substrate 22. The central hole 22c penetrates the second substrate 22 in the thickness direction.

A plurality of through holes 31 are formed in the second substrate 22. The through holes 31 allow the indexes 23 and the frame-shaped protrusion 27 to pass therethrough, so that the indexes 23 and the frame-shaped protrusion 27 are exposed. The through holes 31 penetrate the second substrate 22 from the upper surface 22a to a lower surface of the second substrate 22. The through holes 31 have a shape corresponding to that of the indexes 23 and the frame-shaped protrusion 27. For example, when the indexes 23 to be inserted have a circular shape, the through holes 31 have a circular shape.

The upper surface 22a (second main surface) of the second substrate 22 can be provided with a surface decoration 32 formed by unevenness. The surface decoration 32 may be a pattern such as a striped pattern, a wave pattern, a lattice pattern, a polka-dot pattern, a wood-grain pattern, a stone-grain pattern, a geometric pattern, or a random pattern. The surface decoration 32 is not particularly limited. The surface decoration 32 may indicate, for example, figures designed from animals and plants. The surface decoration 32 can be formed by pressing, molding, cutting, or the like when the second substrate 22 is manufactured.

The upper surface 22a of the second substrate 22 may be subjected to a surface treatment. The surface treatment can be formed by, for example, at least one of coating, printing, wet plating, and dry plating. Examples of the dry plating include physical vapor deposition (PVD) and chemical vapor deposition (CVD). With these surface treatments, designability of the second substrate 22 can be improved.

For example, the second substrate 22 is bonded to the first substrate 21 in a state of being overlapped on the first substrate 21. The second substrate 22 is bonded to the first substrate 21 by, for example, at least one of an adhesive, a double-sided tape, and caulking. The first substrate 21 and the second substrate 22 are bonded and integrated with each other, so that a handling property of the dial 3 is improved.

The second substrate 22 may be detachable from the first substrate 21. Accordingly, the second substrate 22 is easily replaced. Therefore, it is possible to easily cope with a change in design, repair, or the like.

The dial 3 according to the present embodiment includes the first substrate 21 on which the index 23 is formed, and the second substrate 22 overlapped on the first substrate 21. Since there is no index on the second substrate 22, a defect such as deformation is less likely to occur when the surface decoration 32 due to the unevenness is formed. In addition, since the second substrate 22 is separated from the first substrate 21, the second substrate 22 is less likely to be restricted by a thickness of a plate material to be used, and a height of the unevenness of the surface decoration 32 is easily secured. Therefore, the surface decoration 32 having deep unevenness can be formed as compared with a case in which both the index and the surface decoration are formed on the substrate. Thus, the surface decoration 32 having a three-dimensional appearance can be formed. In the dial 3, there are few restrictions on the surface decoration 32, and thus a degree of freedom in design selection can be improved.

In the dial 3 according to the present embodiment, it is possible to polish the upper surface 22a of the second substrate 22 and impart gloss to the upper surface 22a before being bonded to the first substrate 21. Since there is no index on the second substrate 22, the second substrate 22 has a small number of surface protrusions that may hinder the polishing work. Therefore, the polishing work is facilitated.

In the dial 3 according to the present embodiment, since the first substrate 21 is separated from the second substrate 22, any second substrate 22 can be selected and used from a plurality of types of second substrates 22. Therefore, the degree of freedom in design selection can be improved. In the dial 3, since the second substrate 22 is replaceable, it is possible to easily cope with a change in design, repair, or the like.

In the dial 3 according to the present embodiment, each of the first substrate 21 and the second substrate 22 can be prepared by pressing or the like. Therefore, the dial 3 is also excellent in mass productivity, ease of processability, and the like.

### [Timepiece Dial]

### Second Embodiment

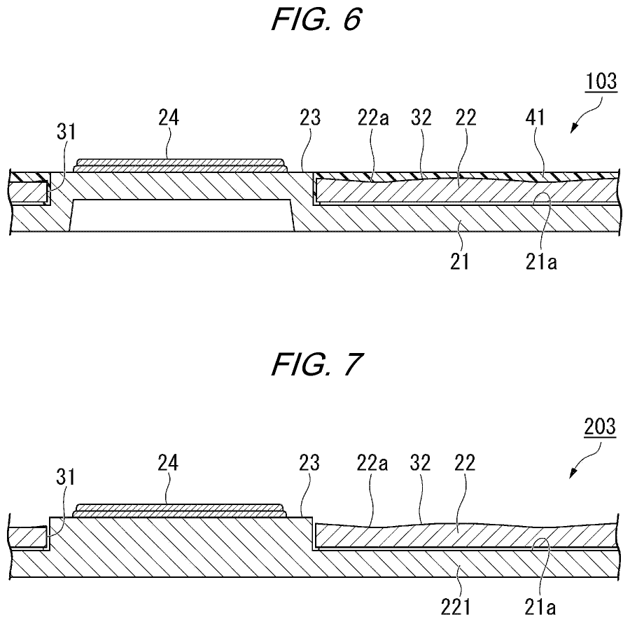

FIG. 6 is a partial cross-sectional view of a dial 103 according to a second embodiment. The same components as those according to the first embodiment are denoted by the same reference numerals, and the description thereof is omitted.

As illustrated in FIG. 6, in the dial 103, a surface of the second substrate 22 is covered with a transparent resin layer 41. The resin layer 41 protects the surface decoration 32 and imparts a three-dimensional and deep visual effect to the surface decoration 32. The resin layer 41 is formed of, for example, a thermoplastic resin such as a polyolefin resin (polypropylene or the like), an ABS resin, or an acrylic resin. The resin layer 41 may be formed of a thermosetting resin such as a melamine resin or a phenol resin.

The resin layer 41 can be formed, for example, in the following manner. A resin in an uncured state is applied to the surface of the second substrate 22, and the resin is cured. A surface of the cured resin is polished. With the polishing, surface unevenness of the resin layer 41 can be reduced and gloss can be imparted to the resin layer 41.

In the dial 103 according to the present embodiment, the surface decoration 32 having a three-dimensional appearance can be formed similarly to the dial 3 according to the first embodiment. The polishing work for imparting gloss to a surface of the dial 103 is also facilitated.

In the dial 103 according to the present embodiment, since the surface of the second substrate 22 is covered with the transparent resin layer 41, a three-dimensional and deep visual effect can be imparted to the surface decoration 32.

### [Timepiece Dial]

### Third Embodiment

FIG. 7 is a partial cross-sectional view of a dial 203 according to a third embodiment. The same components as those according to the first embodiment are denoted by the same reference numerals, and the description thereof is omitted.

As illustrated in FIG. 7, the dial 203 has no recess on a lower surface side of the index 23 of a first substrate 221. In the dial 203, the first substrate 221 including the index 23 can be formed by cutting or the like.

Since the dial 203 according to the present embodiment has no recess on the lower surface side of the index 23 of the first substrate 221, a strength of the first substrate 221 can be enhanced. Therefore, durability of the dial 203 can be enhanced.

The invention is not limited to the embodiments described above with reference to the drawings, and various modifications are conceivable within the technical scope of the invention.

For example, in the dial 3 illustrated in FIG. 3, the index 23 protrudes from the surface of the second substrate 22. Alternatively, an index not protruding from the surface of the second substrate is also possible.

What is claimed is:

1. A timepiece dial comprising:
a first substrate on which an index protrudes from a first main surface; and
a second substrate overlapped on the first main surface, wherein
a through hole through which the index is inserted and exposed is formed in the second substrate, and
a surface decoration having unevenness is formed on the second substrate.

2. The timepiece dial according to claim 1, wherein a surface of the second substrate is covered with a transparent resin layer.

3. The timepiece dial according to claim 1, wherein
the first substrate and the second substrate are formed of one or two or more of a metal, ceramics, glass, and plastics, and
the metal is an alloy containing one or two or more of (A) copper, (B) iron, (C) titanium, (D) gold, (E) silver, and (F) platinum, or an alloy in which one or two or more of (A) to (F) are taken as main components.

4. The timepiece dial according to claim 1, wherein
the second substrate is subjected to a surface treatment by at least one of coating, printing, wet plating, and dry plating.

5. The timepiece dial according to claim 1, wherein
the first substrate and the second substrate are bonded by at least one of an adhesive, a double-sided tape, and caulking.

6. A timepiece comprising:
the timepiece dial according to claim 1.

7. A timepiece comprising:
the timepiece dial according to claim 2.

8. A timepiece comprising:
the timepiece dial according to claim 3.

9. A timepiece comprising:
the timepiece dial according to claim 4.

10. A timepiece comprising:
the timepiece dial according to claim 5.
